(19) United States
(12) Patent Application Publication
(10) Pub. No.: US 2008/0028536 A1
(43) Pub. Date: Feb. 7, 2008

(54) Mattress with cooling airflow

(76) Inventor: Charlesette Hadden-Cook, Leucadia, CA (US)

Correspondence Address: STEVEN W. WEBB, 655 2ND STREET, ENCINITAS, CA, 92024, US

(21) Appl. No.: 11/507,174

(22) Filed: Aug. 21, 2006

Related U.S. Application Data
(60) Provisional application No. 60/835,531, filed on Aug. 4, 2006.

(51) Int. Cl. A61G 7/00; A47C 17/00

(52) U.S. Cl. 5/724; 5/423

(57) ABSTRACT

An improved air mattress pad is presented where a cooling airflow is pumped through the mattress and escapes through the air mattress upper surface. The air mattress pad is designed to be placed on top of an existing bed mattress such that a bed occupant would experience the cooling air flow as desired to reduce the effect of night sweats and hot flashes.

### RELATED APPLICATIONS

This application extends and completes Provisional Patent Application 60/835,531, filed Aug. 4, 2006.

### BACKGROUND OF THE INVENTION

The present invention relates to specialized mattresses and support furniture, designed with medical or comfort features.

### OBJECTS OF THE INVENTION

It is an object of this invention to provide a lightweight mattress pad with embedded air tubes to blow air through the upper surface.

It is an additional object of this invention to make the pad out of sturdy, durable materials with manufactured air holes.

It is an additional object of this invention to provide a separate and attached blower appliance with control pad that pumps cool air through a tube into the mattress, the appliance using household electricity.

It is an additional object of this invention that the pad be capable of being rolled up with the blower appliance inside the rolled up pad.

It is an additional object of this invention that the pad be useable on top of an existing mattress or on the floor or other flat surface.

### BRIEF DESCRIPTION OF THE DRAWINGS

FIG. 1 Perspective view of the preferred embodiment

FIG. 2. Close-up cross-section view of one of the air tubes

### DETAILED DESCRIPTION OF THE INVENTION

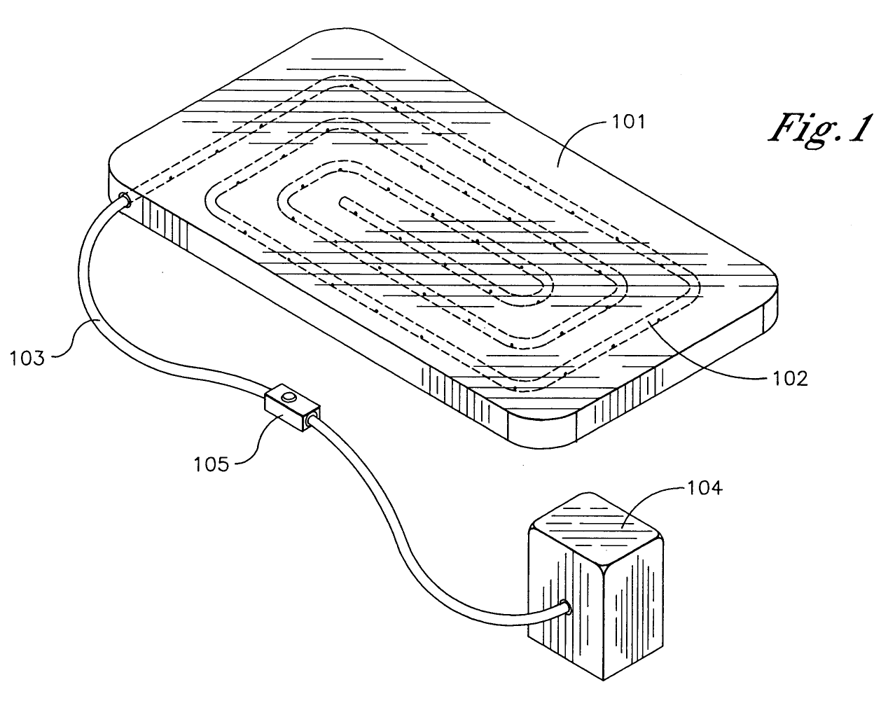

As shown in FIG. 1, this invention consists of a flat mattress pad 101 with a single spiral-pattern air tube 102 embedded in it. The air tube 102 is flexible, has a connection to an outside tube 103 leading to a blower 104 with a control panel 105. The blower 104 forces air through the tube 103 into the air tube 102 in the mattress pad 101, where the air leaves the air tube 102 through a plurality of exit holes 106 through the porous surface of the mattress pad 107. The mattress pad has a mesh or net cover (not shown) over it that can be removed and washed.

The invention 100 can be folded or rolled without damaging the air tube 102, and the blower 104 and control panel 105 can be placed inside the rolled up mattress pad 101 for storage. The mattress pad 101 can be made in a variety of sizes to accommodate the standard mattress sizes, such as king, queen, double, and the like.

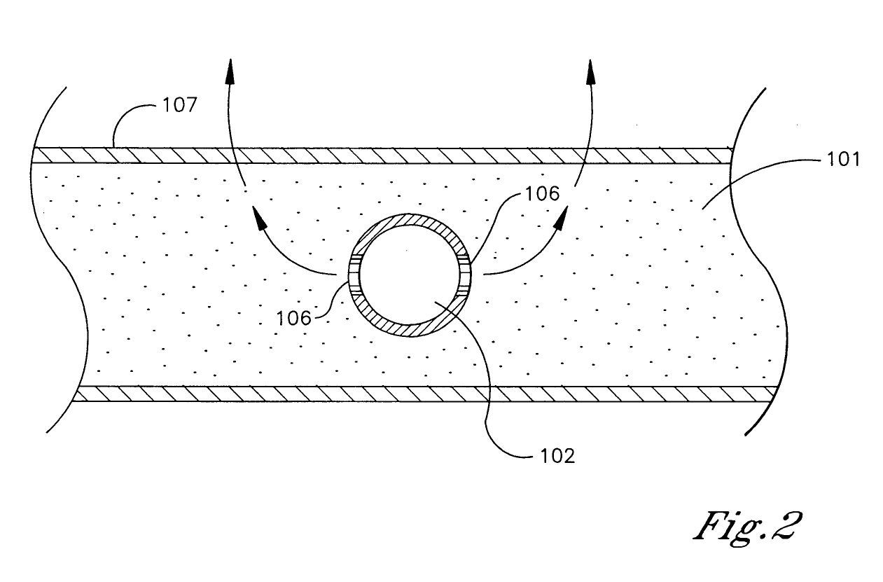

As seen in FIG. 2, the mattress pad 101 is barely thicker than the width of the air tube 102 and the air tube has a porous lining with a plurality of exit holes 106 allowing air to escape through the porous surface 107 of the mattress pad 101. The air holes 106 in the air tube 102 are placed at the “upper” surface of the air tube 102 that corresponds with the “upper” surface of the mattress pad 101.

The blower 104 possesses a dust filter that prevents room dust from the floor from being blown through the mattress pad 101 into the bed. The blower control panel 105 sets a variety of speeds for fan operation and turns the blower 104 on and off.

This invention has other applications, potentially, and one skilled in the art could discover these. The explication of the features of this invention does not limit the claims of this application; other applications developed by those skilled in the art will be included in this invention.

What is claimed is:

1. a mattress pad with cooling airflow, the mattress pad comprised of an air mattress pad, an air tube, an external tube, a blower, and a blower control panel,
the air tube a continuous flexible tube within the air mattress pad that connects to the outside of the air mattress pad at an opening in the air mattress pad,
the air tube connected to an external tube at the opening in the air mattress pad,
the external tube a flexible tube that terminates at its other end in a blower,
the blower an electrically-powered fan that forces air into the end of the external tube and from the external tube into the air tube within the air mattress pad,
the blower control panel a pad with pushbuttons or other control devices that control the operation of the blower,
the air tube possessing a plurality of small air holes in its surface,
the air holes positioned on the surface of the air tube such that the air forced into the air tube is permitted to flow out of the air tube in one direction, the direction of the air flow towards the upper surface of the air mattress pad,
the upper surface of the air mattress pad possessing a porous surface such that the air flow from the air tube escapes from the air mattress pad.

2. the air mattress of claim 1 where the air mattress pad upper surface is covered with a removable porous cover that is washable.
